(19) United States
(12) Patent Application Publication
(10) Pub. No.: US 2010/0096039 A1
(43) Pub. Date: Apr. 22, 2010

(54) METHOD AND APPARATUS RECUPERATING BOIL-OFF VAPOR

(76) Inventor: Rune Midttun, Soreidgrend (NO)

Correspondence Address: CALFEE HALTER & GRISWOLD, LLP, 800 SUPERIOR AVENUE, SUITE 1400, CLEVELAND, OH, 44114, US

(21) Appl. No.: 12/643,432

(22) Filed: Dec. 21, 2009

Related U.S. Application Data
(63) Continuation of application No. 10/503,189, filed on Jun. 16, 2005, now abandoned.

(30) Foreign Application Priority Data
Jan. 30, 2002 (GB) 0202121.0

(51) Int. Cl. B67D 7/04; F25J 1/00; B67D 7/78; B67D 7/80

(52) U.S. Cl. 141/11; 141/69; 141/82; 62/606; 137/206; 137/207.5

(57) ABSTRACT

In a fuel vapour recovery system, fuel vapour is drawn off and converted to liquid fuel. The system comprises a compressor, individually closable inlets for the fuel vapour and leading to an inlet duct of the compressor, a return duct by way of which an outlet of the compressor communicates with the inlet duct, and a control device which controls communication between that outlet and the inlet duct via the return duct in dependence upon the number of the inlets which is open. The system further comprises a tank, a first sensor which serves to detect when liquid water in the tank attains a predetermined height in the tank, a second sensor which serves to detect when liquid fuel in the tank attains a higher, predetermined height in the tank, a first device responsive to the first sensor and serving to cause removal of at least part of the liquid water from the tank when the liquid water attains the first-mentioned predetermined height, and a second device responsive to the second sensor and serving to cause removal of at least part of the liquid fuel from the tank when the liquid fuel attains the higher, predetermined height.

### RELATED APPLICATIONS

This application is a continuation of application Ser. No. 10/503,189 filed Jun. 16, 2005 for METHOD AND APPARATUS RECUPERATING BOIL-OFF VAPOR, which is a national phase entry under 35 U.S.C. §371 and claims priority to International Application No. PCT/GB2003/000405, with an International Filing Date of Jan. 30, 2003, for METHOD AND APPARATUS which claims the benefit of Great Britain patent application serial no. 0202121.0 filed on Jan. 30, 2002, the entire disclosures of which are fully incorporated herein by reference.

According to a first aspect of the present invention, there is provided a method comprising drawing off fuel undesirably in gaseous form, and converting the fuel in gaseous form to a liquid form.

According to a second aspect of the present invention, there is provided apparatus which draws off fuel undesirably in gaseous form and converts the fuel in gaseous form to a liquid form.

Owing to these two aspects of the invention, the fuel [e.g. petrol, diesel oil, aviation fuel (such as jet A1 fuel), or any other fuel that forms VOC (volatile organic compound) gas(es)] in gaseous form (i.e. in the form of a gas, of a vapour, or of a gas/vapour mixture) can be recovered in liquid form. If the method is performed at, for example, a liquid fuel filling site, the fuel recovered in liquid form at the site can be either used in liquid form at the site or transported in liquid form from the site.

According to a third aspect of the present invention, there is provided a method of converting an organic substance in gaseous form to a liquid form, comprising compressing the organic substance in gaseous form.

According to a fourth aspect of the present invention, there is provided an apparatus for converting an organic substance in gaseous form to a liquid form, comprising a compressor which serves to compress the substance in gaseous form.

Owing to these two aspects of the invention, the energy removal necessary to condense the organic substance in gaseous form can be performed at a higher temperature, e.g. at ambient temperature, reducing the amount of cooling which would otherwise be required.

According to a fifth aspect of the present invention, there is provided a method of compressing gaseous matter, comprising opening a plurality of inlets, operating a compressor to draw the gaseous matter through the inlets to an inlet duct of said compressor and to expel said gaseous matter through an outlet of said compressor, closing at least one of said inlets, and operating said compressor to draw the gaseous matter through the open inlet(s) to said inlet duct, to expel the gaseous matter through said outlet and to return at least part of that expelled gaseous matter to upstream of said compressor.

According to a sixth aspect of the present invention, there is provided apparatus for compressing gaseous matter, comprising a compressor, an inlet duct of said compressor, an outlet of said compressor, a plurality of individually closable inlets for the gaseous matter and leading to the inlet duct, a return duct by way of which said outlet communicates with said inlet duct, and a control device which controls communication between said outlet and said inlet duct via said return duct in dependence upon the number of said inlets which is open.

Owing to these two aspects of the invention, it is possible to avoid significantly higher negative pressures arising at (an) open inlet(s) during the times that the other inlet(s) is/are closed compared with the negative pressures at the inlets during the times that all of them are open.

According to a seventh aspect of the present invention, there is provided a method comprising sensing when a heavier fluid attains a predetermined height in a tank, removing at least part of said heavier fluid from said tank when said predetermined height is attained, sensing when a lighter fluid attains a predetermined height in said tank, and removing at least part of said lighter fluid from said tank when the latter predetermined height is attained.

According to an eighth aspect of the present invention, there is provided apparatus comprising a tank, a first sensor which serves to detect when a heavier fluid in said tank attains a predetermined height in said tank, a second sensor which serves to detect when a lighter fluid in said tank attains a predetermined height in said tank, a first device responsive to said first sensor and serving to cause removal of at least part of said heavier fluid from said tank when said heavier fluid attains the first-mentioned predetermined height, and a second device responsive to said second sensor and serving to cause removal of at least part of said lighter fluid from said tank when said lighter fluid attains the second-mentioned predetermined height.

Owing to these two aspects of the invention, it is possible to control the volumes of the heavier and lighter fluids present in the tank.

The heavier and lighter fluids will normally both be liquids and may have an even lighter fluid, which will normally be of gaseous form, above the lighter liquid, with that even lighter fluid being removed from the tank as desired. The fluids can be removed from the tank simply through the opening of valves, if subject to pressure in the tank.

In order that the invention may be clearly and completely disclosed, reference will now be made, by way of example, to the accompanying drawings, in which:

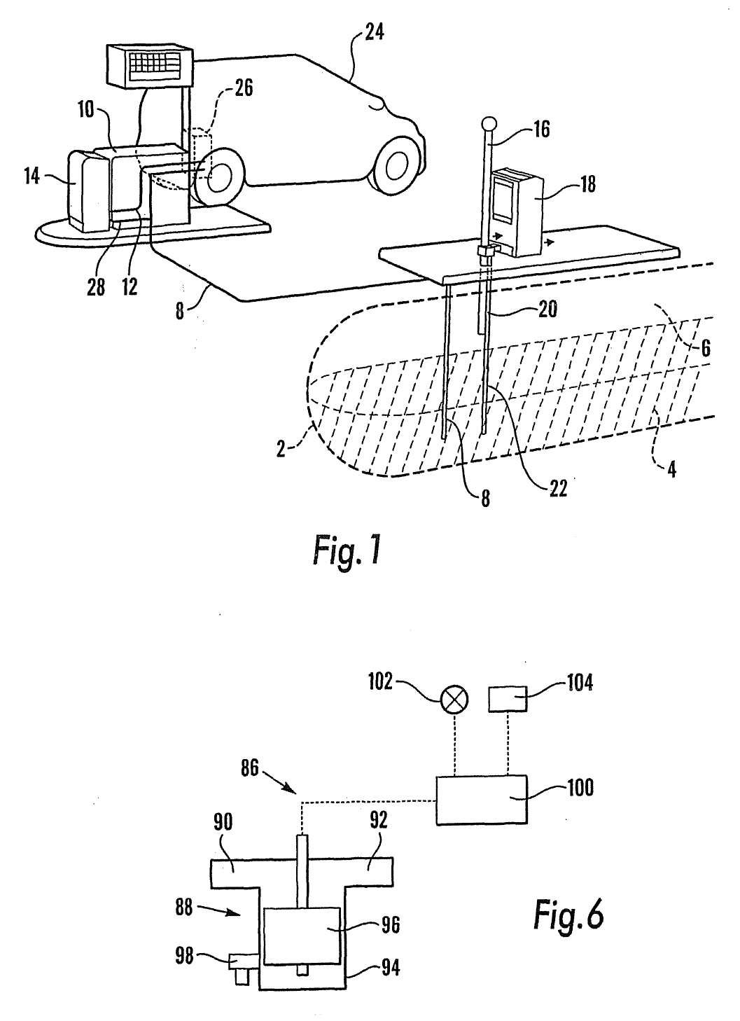

FIG. 1 is a diagrammatic perspective view of a liquid fuel filling station,

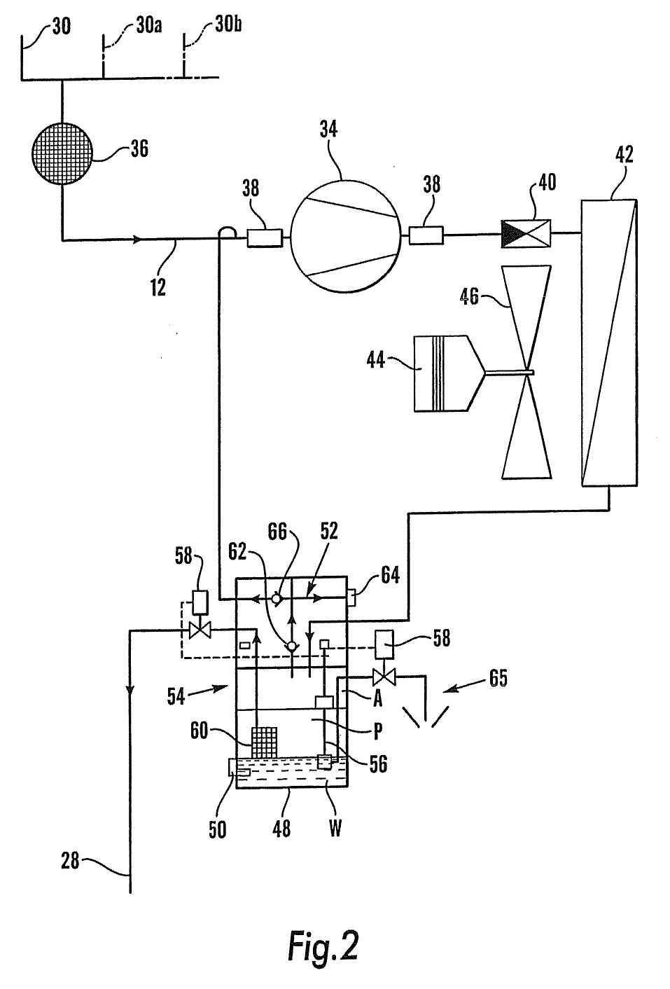

FIG. 2 is a diagram of a vapour recovery system at the station and showing one of a plurality of vapour recovery units of the system,

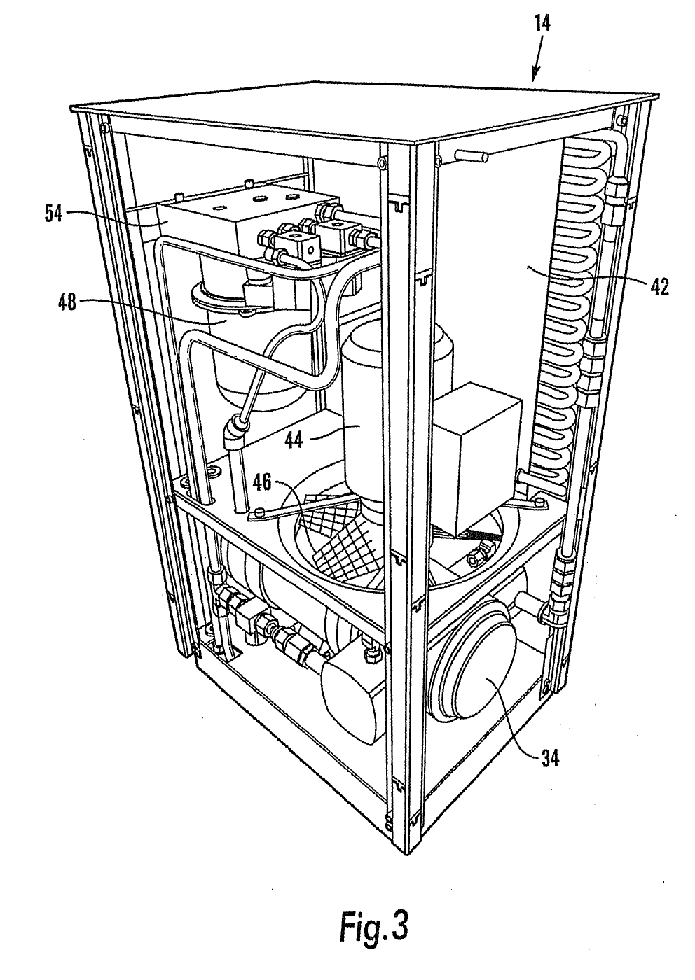

FIG. 3 is a perspective view, with panels removed for ease of illustration, of that vapour recovery unit of the system,

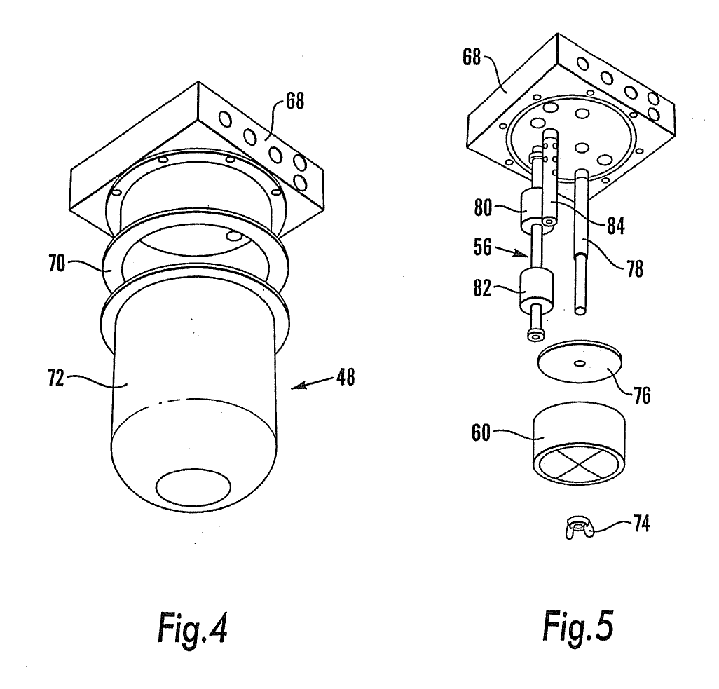

FIGS. 4 and 5 are underneath, exploded, perspective views of external and internal items of a multi-function tank of the unit, and

FIG. 6 is a diagram of a leak detection arrangement of the unit.

Referring to FIG. 1, the station includes an underground storage tank 2 for liquid petrol 4, but with undesired air/petrol vapour mixture 6 above the petrol 4. A petrol delivery pipe (i.e. pump suction line) 8 extends from the tank 2 to a petrol pump 10 (usually a multi-pump) and a vapour return line 12 extends to a vapour recovery unit 14.

At a main ventilation pipe 16 for the tank 2 is another vapour recovery unit 18 virtually identical to the unit 14 and connected to the ventilation pipe 16 by a vapour outlet line 20. The unit 18, which converts petrol vapour from the line 20 into liquid petrol and returns it to the tank 2 via a petrol return line 22 need not be described in further detail. A motor car 24 is shown parked beside the pump 10 having its petrol tank 26 being filled from the pump 10. The vapour return line 12 from a filling nozzle 30 (see FIG. 2) of the pump 10 leads to the unit 14 where the vapour is converted into liquid petrol which is returned via a petrol outlet line 28 to the delivery line 8 (although, if desired, it could instead be returned to the tank 2, such as via an existing return line to the tank 2 conventionally used for returning petrol vapour to the tank 2).

Referring to FIG. 2, the vapour recovery system incorporating the unit 14 will now be described in more detail. During filling, vapour contaminated with some air is sucked from the fill-pipe of the car 24 through the filling nozzle 30 and the line 12 in the form of a hose and a pipe, by means of an oil-free compressor 34. Before entering the compressor 34, the vapour is filtered in a particles filter 36. The inlet and outlet of the compressor 34 are equipped with flame arrestors 38 for safety, and the outlet has a non-return valve 40 to prevent flow reversal. The petrol vapour (and water vapour from moist air) enter(s) an air-cooled heat exchanger 42 where the vapour(s) condense(s) and enter(s) the liquid state(s). During the compression the vapour(s) undergo(es) a small temperature rise. With an ambient temperature of 40° C. the outlet temperature from the compressor 34 could be up to 55° C.

In the heat exchanger 42 energy is released from the petrol and water vapours. A separate motor 44 operates a fan 46 for the heat exchanger 42. The fan 46 automatically stops when the ambient temperature drops to about 5° C.

Condensates and non-condensable gaseous matter, mainly air, flow into a multi-function tank 48 where the water W, denser than the petrol P, accumulates at the bottom, with the petrol P above it and the air A above that. If required, a heater cable 50 is provided to prevent water from freezing in the tank 48 at low temperatures.

A pressure controller 52 in a module 54 containing the multi-function tank 48 keeps the condenser pressure at a constant level.

A float switch 56 senses the levels of water and petrol in the tank 48 and operates solenoid valves 58, to drain off the water W and the petrol P under the action of the internal pressure in the tank 48. The petrol is drained off via a mud- and water-blocking filter 60 through the relevant solenoid valve 58 into the line 28.

Via a high pressure regulator 62 of the controller 52, air and minor amounts of petrol vapour and water vapour. pass through to a receiver (an un-illustrated intermediate chamber) and are discharged through a combined bleeder nozzle/flame arrestor 64 to the ambient atmosphere. The water W is discharged to a drain 65.

The system described with reference to FIG. 2 is suited to a multi-pump since it can accommodate more than one filling nozzle 30, e.g. two or more nozzles 30,30a, 30b, etc. In those circumstances, during reduced load, e.g. only one filling nozzle 30 in use, the compressor 34 causes more air to enter the system and the pressure at the bleeder nozzle/flame arrestor 64 increases. At a certain pressure level, a low pressure regulator 66 in the controller 52 opens for air return to the compressor inlet. In this way, an automatic capacity control is achieved and this ensures efficient suction at the filling nozzle.

There would be an insignificant amount of petrol vapour mixed with the air from the bleeder nozzle/flame arrestor 64. This amount could be about 2% to 3% of the total circulation capacity of the system, but the rate of recovered petrol vapour still exceeds all known requirements for petrol vapour recovery at petrol stations.

Referring to FIGS. 4 and 5, the multi-function tank module 54 includes a manifold block 68 to the underside of which is fixed, by way of a fluid-tight sealing ring 70, an open-topped body 72 of the tank 48. Within that tank are the filter 60 mounted, by way of a wing nut 74 and with the interposition of a disc 76, on a pipe 78 leading towards the relevant solenoid valve 58. The float switch 56 has upper and lower floats 80 and 82 for floating on the petrol P and the water W, respectively. An inlet pipe 84 from the heat exchanger 42 is also shown.

Referring to FIG. 6, the unit 14 may contain an automatic leak detection arrangement 86 which stops the compressor 34 when liquid is detected in the inlet line 12. Inserted in the line 12 is a module 88 including an inlet connector 90, an outlet connector 92, a container 94 between the two connectors 90 and 92, a float switch 96 associated with the container 94, and a manual or automatic drain 98 for the container 94. Electrically connected to the float switch 96 is an electronic control device 100 which controls an alarm/failure lamp 102 and a relay 104 controlling the compressor 34.

Petrol vapour and air enter the leak detector through the inlet connector 90 and leave through the outlet connector 92. The float switch 96 floats up and sends an electronic signal whenever a volume above, say, 25-30 ml. accumulates in the container 94. The signal is sent to the device 100 which then illuminates the lamp 102 and actuates the relay 104 to cut off the electrical supply to the compressor 34.

The unit shown in FIG. 3 is constructed as an attachment to almost any existing fuel pump, or to any ventilation pipe from a main fuel tank underground or any fuel tank emitting VOC gas(es). The unit differs from conventional vapour recovery systems because it:
transforms fuel vapour into liquid fuel (i.e. it does not only suck off vapour);
requires no new piping below the surface or digging in order to be associated with a fuel pump;
interacts with only the start and stop signal from the fuel pump and therefore not with the flow rate of the pump, thus being independent of the flow rate;
sends liquid fuel directly back into the fuel flow of the pump (or into existing vapour return piping if necessary).

The unit is usable with any vapour-recovery-equipped filling nozzle and any flexible hose having a vapour return line. It co-operates with one filling nozzle, or with two or more filling nozzles simultaneously, by means of mechanical, step-less adjustment.

The unit is installed alongside the fuel pump, bolted onto the ground. It is connected to the pump through an inlet connection pipe or hose that delivers the mixture of vapour and air into the unit. Furthermore, another connection through a pipe or hose ensures the return of liquid fuel into the suction side of the fuel pumping device of the fuel pump, the pressure side of that device, or return piping for VOC gas(es) if such piping is already present.

If feasible, the unit takes its operating power from the electricity supply of the fuel pump.

The unit is switched on and off with the start and stop signals of the pump, and operates whenever one or more filling nozzles on the pump are in operation. When no nozzles are in operation, the unit is automatically turned off.

The basic function of the unit is to transform fuel vapour into liquid fuel while separating the air (and water) and bleeding off the air. Basically, what takes place during the operation of the unit is that:—
1. An uncompressed mixture of fuel vapour and air is sucked into the unit through the vapour recovery filling nozzle.
2. The compressor raises the pressure of the mixture to a level where the fuel vapour components can be condensed with minimal refrigeration requirements, so that the conversion from vapour to fuel is particularly cost-effective.
3. The pressurised vapour/air mixture is fed by the compressor to the heat exchanger.
4. The heat exchanger is cooled at the ambient temperature. This minor decrease in temperature is sufficient to release the amount of energy from the fuel vapour that is required to transform it into liquid fuel, but the air remains a gas.
5. Liquid fuel and air are fed from the heat exchanger to the multi-function tank.
6. The combined mud and water filter sees to it that any dust/mud/other particles or water is separated from the liquid fuel flow.
7. Water—if any—is evacuated through the separate water drain.
8. The tank accumulates liquid fuel and lets the air portion through.
9. Liquid fuel without any air or water is sent from the tank to the fuel outlet.
10. Pressurised air (containing a small percentage of fuel vapour) is released via the bleeder nozzle/flame arrestor.

The present system is applicable not only to fuel vapour recovery at fuel stations, but also to various other possibilities of recovery of substances, particularly organic substances, in gaseous form. For example, it could be employed for storage tanks or other vessels containing liquid that forms VOC gas(es).

Having thus described the many embodiments, the invention is now claimed to be:

1. A method comprising storing liquid fuel in a liquid fuel storage tank, withdrawing liquid fuel from said storage tank, dispensing withdrawn liquid fuel into a fuel tank of a vehicle by means of a liquid fuel dispensing device, drawing off fuel undesirably in gaseous form at said dispensing device, converting the fuel in gaseous form to a liquid form, and leading the liquid fuel converted from a gaseous form to said dispensing device in such manner as to bypass said storage tank.

2. A method according to claim 1, wherein said converting comprises compressing the fuel in gaseous form in a compressor and is without using said liquid fuel as a coolant for said fuel in gaseous form.

3. A method according to claim 2, wherein said converting further comprises condensing the compressed fuel in gaseous form to said fuel in liquid form.

4. A method according to claim 3, wherein said condensing comprises passing the fuel in gaseous form into a heat exchanger and air-cooling the heat exchanger.

5. A method according to claim 2, wherein part of the fuel in gaseous form expelled from the compressor is returned to upstream of the compressor.

6. A method according to claim 2, wherein said converting is accompanied by converting water vapour into liquid water, and wherein said liquid water and said fuel in liquid form are fed to a tank, said method further comprising sensing when the liquid water attains a predetermined height in said tank, removing at least part of said liquid water from said tank when said predetermined height is attained, sensing when the fuel in liquid form attains a higher, predetermined height in said tank, and removing at least part of said fuel in liquid form from said tank when the higher, predetermined height is attained, fuel in gaseous form being present in said tank above the fuel in liquid form, said method further comprising removing from the tank that fuel in gaseous form and returning the same to upstream of said compressor.

7. A method of converting an organic substance in gaseous form to a liquid form, comprising compressing the organic substance in gaseous form in a compressing stage, and condensing the compressed organic substance in gaseous form in a condensing stage.

8. A method according to claim 7, wherein said converting is accompanied by converting a second substance in gaseous form into said second substance in liquid form, and wherein said organic substance in liquid form and said second substance in liquid form are fed to a tank, said method further comprising sensing when the second substance in liquid form attains a predetermined height in said tank, removing at least part of said second substance in liquid form from said tank when said predetermined height is attained, sensing when the organic substance in liquid form attains a higher, predetermined height in said tank, and removing at least part of said organic substance in liquid form from said tank when the latter predetermined height is attained, organic substance in gaseous form being present in said tank above said organic substance in liquid form, said method further comprising removing from the tank that organic substance in gaseous form and returning the same to upstream of said compressing stage.

9. An apparatus for converting an organic substance in gaseous form to a liquid form, comprising a compressor which serves to compress the substance in gaseous form, and a condenser which serves to condense the compressed organic substance in gaseous form.

10. Apparatus according to claim 9, and further comprising a tank, a first sensor which serves to detect when a second substance in liquid form in said tank attains a predetermined height in said tank, a second sensor which serves to detect when said organic substance in liquid form in said tank attains a higher, predetermined height in said tank, a first device responsive to said first sensor and serving to cause removal of at least part of said second substance in liquid form from said tank when said second substance in liquid form attains the first-mentioned predetermined height, and a second device responsive to said second sensor and serving to cause removal of at least part of said organic substance in liquid form from said tank when said organic substance in liquid form attains the higher, predetermined height, said compressor serving to subject the interior of said tank to pressure, said apparatus further comprising at least one valve openable to allow at least said organic substance in liquid form to flow from the tank under the action of said pressure to upstream of said compressor.

11. A module comprising a separation tank, a first sensor which serves to detect when a heavier fluid in said tank attains a predetermined height in said tank, a second sensor which serves to detect when a lighter fluid in said tank attains a predetermined height in said tank, and a pressure controller for controlling pressure in apparatus external to said module.

12. A unit comprising a module according to claim 11 and a converting arrangement upstream of said tank and constituting said apparatus for converting said heavier fluid and said lighter fluid when in a gaseous form into respective liquids which are fed to said tank, said converting arrangement comprising a condenser, and said controller serving to control the pressure in said condenser.

13. A liquid fuel dispensing station comprising a liquid fuel storage tank, a liquid fuel dispensing arrangement serving to dispense liquid fuel into vehicle fuel tanks and to draw off fuel undesirably in gaseous form, a liquid fuel delivery line extending from said storage tank to said dispensing arrangement, a converting arrangement which serves to convert the fuel in gaseous form to a liquid form, a first-path, for said fuel in gaseous form, from said dispensing arrangement to said converting arrangement, and a second path, for the liquid fuel converted from gaseous form, from said converting arrangement to said delivery line other than by way of said storage tank.

14. A station according to claim 13, and further comprising a separation tank in said second path, a first sensor which serves to detect when liquid water in said separation tank attains a predetermined height in said tank, a second sensor which serves to detect when said fuel in liquid form in said separation tank attains a higher, predetermined height in said separation tank, a first device responsive to said first sensor and serving to cause removal of at least part of said liquid water from said separation tank when said liquid water attains the first-mentioned predetermined height, and a second device responsive to said second sensor and serving to cause removal of at least part of said fuel in liquid form from said separation tank when said fuel in liquid form attains the higher, predetermined height, said converting arrangement comprising a compressor for compressing the fuel in gaseous form, an inlet duct of said compressor, and an outlet of said compressor, said compressor serving to subject the interior of said separation tank to pressure, and said station further comprising at least one valve openable to allow at least the fuel in liquid form to flow from the separation tank under the action of said pressure.

15. A station according to claim 13, wherein said converting arrangement comprises a compressor for compressing the fuel in gaseous form, said first path comprises an inlet duct of said compressor, and said compressor has an outlet.

16. A station according to claim 15, wherein said converting arrangement further comprises a condenser downstream of said compressor.

17. A station according to claim 16, wherein said condenser comprises an air-cooled heat exchanger.

18. A station according to claim 16, and further comprising a pressure controller serving to maintain the pressure in the condenser at a constant level, a separation tank in said second path, a first sensor which serves to detect when liquid water in said separation tank attains a predetermined height in said tank, a second sensor which serves to detect when said fuel in liquid form in said separation tank attains a higher, predetermined height in said separation tank, a first device responsive to said first sensor and serving to cause removal of at least part of said liquid water from said separation tank when said liquid water attains the first-mentioned predetermined height, and a second device responsive to said second sensor and serving to cause removal of at least part of said fuel in liquid form from said separation tank when said fuel in liquid form attains the higher, predetermined height, said separation tank being contained in a module in which are said pressure controller, said first sensor and said second sensor.

19. A station according to claim 15, and further comprising an automatic leak detecting arrangement serving to stop said compressor when liquid is detected in said first path.

20. A station according to claim 13, wherein a unit comprising said converting arrangement is installed adjacent said dispensing arrangement.

21. A station according to claim 20, wherein said unit further comprises a separation tank in said second path, a first sensor which serves to detect when liquid water in said separation tank attains a predetermined height in said tank, a second sensor which serves to detect when said fuel in liquid form in said separation tank attains a higher, predetermined height in said tank, a first device responsive to said first sensor and serving to cause removal of at least part of said liquid water from said separation tank when said liquid water attains the first-mentioned predetermined height, and a second device responsive to said second sensor and serving to cause removal of at least part of said fuel in liquid form from said separation tank when said fuel in liquid form attains the higher, predetermined height.

22. A method of transforming fuel vapour into liquid fuel and separating air therefrom, comprising sucking an uncompressed mixture of fuel vapour and air into an apparatus through a vapour recovery filling nozzle; raising the pressure of the mixture; feeding the pressurised vapour/air mixture to a heat exchanger, while cooling the heat exchanger to release an amount of energy from the fuel vapour to transform it into liquid fuel, but the air in the mixture remaining a gas; feeding liquid fuel and air from the heat exchanger to a separation tank; separating any dust/mud/other particles or water in the tank from the liquid fuel flow; evacuating from the tank water in the tank; accumulating liquid fuel in the tank; sending liquid fuel, without any air or water, from the tank to a fuel outlet; and releasing pressurised air from the tank.
